(19) United States
(12) Patent Application Publication
(10) Pub. No.: US 2017/0347672 A1
(43) Pub. Date: Dec. 7, 2017

(54) Packaged Frozen Precooked Dough or Batter-Based Food Products and Methods

(71) Applicant: General Mills, Inc., Minneapolis, MN (US)

(72) Inventors: Thomas J. Arthur, Champlin, MN (US); Anita L. Fischbach, West St. Paul, MN (US); Andrea Stransky, Minneapolis, MN (US); Robert A. Zoss, Plymouth, MN (US); Bruce D. Larson, Monticello, MN (US)

(73) Assignee: General Mills, Inc., Minneapolis, MN (US)

(21) Appl. No.: 15/683,218

(22) Filed: Aug. 22, 2017

Related U.S. Application Data
(63) Continuation of application No. 12/636,133, filed on Dec. 11, 2009, now abandoned.
(60) Provisional application No. 61/201,670, filed on Dec. 12, 2008.

(51) Int. Cl. A21D 15/02; B65D 81/34; A21D 17/00; B65D 77/22

(52) U.S. Cl. CPC A21D 15/02; B65D 77/225; B65D 81/343; A21D 17/004; B65D 2205/00; B65D 2581/3405; B65D 81/3461

(57) ABSTRACT

Disclosed are packaged frozen precooked dough or batter-based food products and methods of heating the food products. The packaged precooked frozen dough or batter-based food products comprises one or more frozen precooked dough or batter-based food products that are encased in a pouch for heating. The pouch is sealed with the exception of the presence of two or more vent holes that function to release air or steam that may otherwise cause the food product to become soggy when they are heated in an oven.

### CROSS-REFERENCE TO RELATED APPLICATIONS

This application represents a continuation application of U.S. Ser. No. 12/636,133, filed Dec. 11, 2009, and entitled PACKAGED FROZEN PRECOOKED DOUGH OR BATTER-BASED FOOD PRODUCTS AND METHODS, which claims the benefit of U.S. Ser. No. 61/201,670, filed Dec. 12, 2008, and entitled PACKAGED FROZEN PRECOOKED BREAKFAST FOOD PRODUCTS AND METHODS. The entire contents of these applications are incorporated herein by reference.

### BACKGROUND

Precooked frozen food products are very desirable to the consumer since they can be stored for long periods of time in a frozen state and then heated quickly in a conventional oven, convection oven, or microwave oven for consumption.

Precooked frozen dough or batter-based food products (e.g., pancakes, French toast, fruit filled Danish, breadsticks, scones, donuts, waffles, muffins, pizza rolls, and cinnamon rolls) are particularly challenging to heat from a frozen state to the optimal temperature state for consumption. The precooked frozen food products may become dry and tough if the heating conditions are too high or too long, or may become moist and soggy if the amount of moisture in the food product is too great.

As a further complication, in some instances, after a frozen food product has been heated, the food product must be held in a heated state at a desirable serving temperature until the food is served. For example, when serving large groups, a large amount of food must be prepared for serving to the group at the same time. This may involve heating the frozen food product in batches, and then holding the heated food at the desired serving temperature until all the food has been prepared and is ready to serve. The holding process may cause the food properties to deteriorate such that the food products are undesirable (e.g., too soggy or dry) at the serving time.

In view of the foregoing, what is desired is a precooked frozen dough or batter-based food product that can be heated from a frozen state to a desired temperature (e.g., 150° F. (65.6° C.)), and may be held at the desired temperature for a holding period (e.g., 240 minutes) while maintaining the desired moisture content and other properties.

### SUMMARY

The invention relates to packaged frozen precooked dough or batter-based food products and to methods of heating the food products. The packaged precooked frozen dough or batter-based food product comprises one or more frozen precooked dough or batter-based food products that are encased in a pouch for heating. The pouch is sealed with the exception of the presence of two or more vent holes that function to release air or steam that may cause the food product to become soggy when the food product is heated in an oven (e.g., microwave, convection conventional oven). The amount of venting in the pouch also controls the headspace atmosphere in the pouch so that the food products do not dry out excessively with extended warm hold time.

In one aspect, the invention relates to a packaged frozen precooked dough or batter-based food product comprising: (a) one or more frozen precooked dough or batter-based food products; and (b) a heatable pouch that encases the one or more frozen precooked dough or batter-based food products; wherein the heatable pouch includes two or more vent holes that provide a vent area ratio ranging from about 0.00005 to about 0.1 (vent area m²/pouch area m²).

In another aspect, the invention relates to a method of preparing a heated dough or batter-based food product, the method comprising the steps of: (a) providing one or more frozen precooked dough or batter-based food products that are encased in a heatable pouch; wherein the heatable pouch includes two or more vent holes that provide a vent area ratio ranging from about 0.00005 to about 0.1 (vent area m²/pouch area m²); and (b) heating the frozen precooked dough or batter-based food products in the heatable pouch in order to form a heated dough or batter-based food product.

In yet another aspect, the invention relates to a method of preparing a heated dough or batter-based food product from a packaged frozen precooked dough or batter-based food product, the method comprising the steps of: (a) providing one or more frozen precooked dough or batter-based food products encased in a heatable pouch; wherein the heatable pouch includes two or more vent holes that provide a vent area ratio ranging from about 0.00005 to about 0.1 (vent area m²/pouch area m²); (b) heating the frozen precooked dough or batter-based food products in the heatable pouch in order to form a heated dough or batter-based food product; and (c) holding the heated dough or batter-based food products at a desired temperature for consumption.

### BRIEF DESCRIPTION OF THE DRAWINGS

The accompanying drawings, which are incorporated in and constitute a part of this specification, illustrate several aspects of the invention and together with the description of the preferred embodiments, serve to explain the principles of the invention. A brief description of the drawings is as follows:

FIG. 1 is a perspective front view of an embodiment of packaged precooked frozen dough or batter-based food product of the invention.

FIG. 1A is perspective back view of an embodiment of packaged precooked frozen dough or batter-based food product of the invention.

FIG. 1B is a cross sectional view of the embodiment of FIG. 1 taken along line 1B-1B.

FIG. 2 is a graph displaying crust moisture as a function of vent area ratio.

FIG. 3 is a graph displaying crust moisture as a function of vent area ratio at various hold times.

FIG. 4 is a graph displaying crust moisture as a function of the number of vent holes at constant vent area ratio.

FIG. 5 is a graph displaying crust moisture percent as a function of vent area ratio for fruit filled danish for a period of 5 hours of hold time in a warming cabinet at 150° F. (65.6° C.).

FIG. 6 is a graph displaying crust moisture percent as a function of vent area ratio for French toast for a period of 5 hours of hold time in a warming cabinet at 150° F. (65.6° C.).

FIG. 7 is a graph displaying crust moisture percent as a function of vent area ratio for breadsticks for a period of 4 hours of hold time in a warming cabinet at 150° F. (65.6° C.).

FIG. 8 is a graph displaying scone crust moisture percent as a function of vent area ratio for a period of about 4 hours in a warming cabinet at 150° F. (65.6° C.).

FIG. 9 is a graph displaying pizza roll crust moisture percent as a function of vent area ratio for a period of about 4 hours in a warming cabinet at 150° F. (65.6° C.).

### DETAILED DESCRIPTION

Embodiments of the invention described herein are not intended to be exhaustive or to limit the invention to the particular embodiments disclosed in the following detailed description. Rather, the embodiments are described so that others skilled in the relevant arts can understand the principles and practices of the present invention.

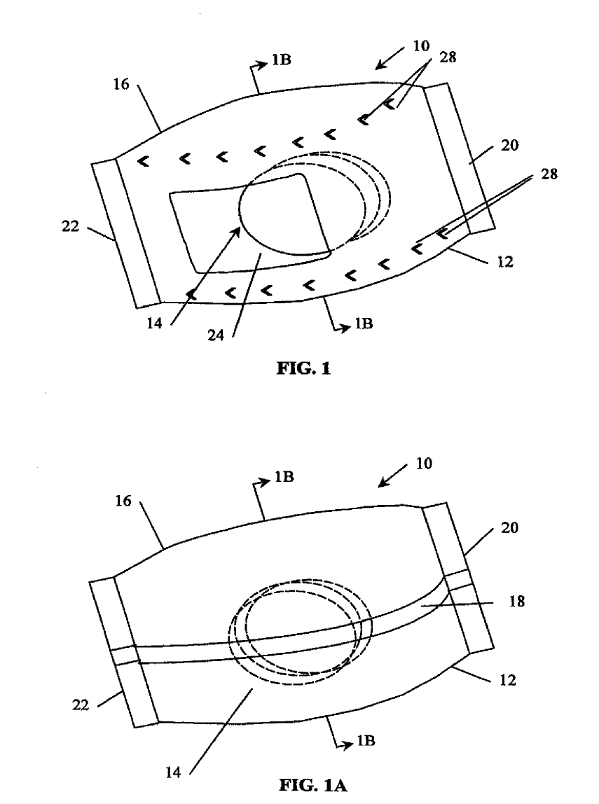

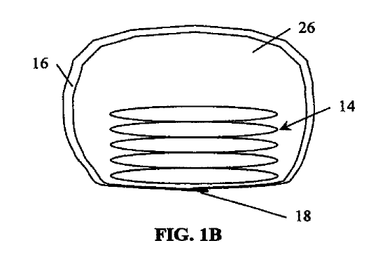

Referring now to FIG. 1, a front perspective view of an embodiment of the invention is shown. Packaged precooked frozen dough or batter-based food product 10 includes heatable pouch 12 that encases one or more precooked frozen dough or batter based food products 14. Pouch 12 is formed from film 16 that is sealed to form longitudinal seam 18 and end seams 20 and 22 as shown in FIG. 1A. Pouch 12 also optionally includes transparent window 24 that allows the food product 14 to be viewed from the exterior of the pouch.

As shown in FIG. 1B, which is a cross-sectional view of pouch 12 taken along line B-B, film 16 defines cavity 26, which holds one or more precooked frozen dough or batter-based food products 14. In FIG. 1B, the dough or batter-based food products 14 depicted are pancakes, although fruit filled Danish, waffles, French toast, scones, breadsticks, donut, muffins, cinnamon rolls, pizza rolls, and the like may also be contained within the cavity.

As shown in FIG. 1, film 16 includes a series of vent holes 28 for allowing steam and air to escape from the cavity 26 of pouch 12 when the pouch is exposed to heat. In the embodiment of FIG. 1, the vent holes 28 are in a linear arrangement, although other arrangements of the vent holes on the pouch 12 are also within the scope of the invention. Other vent hole configurations include, for example, laser perforations resulting in a linear vent.

Any heat stable film capable of being formed into at least a portion of a package may be used in the present method and many such films, also known as “heatable” or “cook-in” films, are known. Typically, such films are comprised of polymeric materials, including, for example, polyesters such as polyethylene terephthalate, nylon, and the like. A useful film may include a single layer of polymeric material, or multiple layers of various different polymeric materials corresponding to various functions. Examples of multi-layer materials including one or a combination of layers (e.g., co-extruded or laminated layers, which function as, e.g.: barrier material layers such as an oxygen barrier layer, a carbon dioxide barrier layer, a moisture barrier layer, or one or more layers that perform a combination of these barrier properties; a layer that contains coated or embedded graphics; a layer that contains a chemical scavenger such as a carbon dioxide or an oxygen scavenger; an adhesive layer such as a thermoplastic adhesive layer; or combinations of these and other layers of materials that may be useful. Commercially available examples of such films include those sold under the trade designation Mylar (E.I. du Pont de Nemours, Wilmington Del.), Nylon 6 and Nylon 66 (E.I. du Pont de Nemours, Wilmington Del.), and Milprint Ovenable Film (Milprint, Oshkosh Wis.).

The heatable pouch includes two or more vent holes in the film. During heating of the food product, the vent holes allow heat or steam to escape from the cavity of the pouch. The number, size, shape, and arrangement of the vent holes in the pouch are selected to provide desired food product properties including, for example, moisture content, food temperature, relative humidity, and amount of condensation in the pouch. In some embodiments, the pouch contains about 20 or less vent holes, for example, about 15 or less vent holes, or about 6 to 12 vent holes. Other vent hole amounts may also be useful. In some embodiments, the number, size, and arrangement of the vent holes are chosen in order to provide a product moisture content that ranges from about 10% to about 60% moisture, for example, when the food product is heated at about 325° F. (163° C.) to about 375° F. (191° C.) for a time period of about 7 to about 15 minutes.

In many embodiments, the vent holes in the pouch provide a vent area ratio that ranges from about 0.00005 to about 0.1 (m² vent area/m² pouch area), or from about 0.00005 to about 0.01 (m² vent area/m² pouch area), or from about 0.00005 to about 0.001 (m² vent area/m² pouch area). Vent area ratio refers to the ratio of vent area to pouch area. Vent area refers to the combined open area of all vent holes in the pouch measured in square meters. Pouch area refers to the surface area of the pouch measured in square meters. Any desired shape may be used for the vent holes. For example, the vent holes may be circular, triangular, square, T-shaped, V-shaped, hexagonal, or linear. The vent holes may be distributed on the pouch in any desired arrangement or pattern. In many embodiments, the vent holes are positioned along an edge of the pouch in a linear arrangement. The vent holes may be formed by any convenient process for creating vent holes with controlled sizes in heatable films. Examples include rotary dies or laser perforation devices. The holes may be placed in the heatable film either prior to forming the film into a pouch or after the pouch has been formed.

The vent area ratio may be selected to provide a desired crust moisture content in the heated food product. For example, the vent area ratio may be selected to provide a crust moisture content of about 15% to about 45% in the heated food product. The desired moisture content depends upon the type of frozen precooked dough or batter-based food product that is being heated. For example, a vent area ratio may be selected to provide a crust moisture of about 10% to about 20% for donuts, or about 35% to about 45% for pancakes.

Precooked dough or batter-based food products suitable for use in the present invention include, for example, pancakes, fruit filled Danish, scones, donuts, pizza rolls, breadsticks, muffins, waffles, French toast, and cinnamon rolls. In many embodiments, the precooked dough or batter-based food products are miniature in size, and the pouch contains 1 or more, typically about 4 to about 10 of the dough or batter-based food products in each pouch. For example, in some embodiments, the pancakes or waffles range in diameter from about 1 inch to about 3.5 inches (2.54 cm to 8.89 cm). The French toast may be in the form of slices (i.e., approximately square) or sticks (i.e., rectangular). In some embodiments, the French toast is in the form of sticks having a size of about 0.5 inch by about 3 inches (1.27 cm to 7.62 cm). In some embodiments, the food product is a fruit filled Danish, for example having a volume ranging from about 8 in³ to about 15 in³ (131 cm³ to 245 cm³). In some embodiments, the food product is a miniature muffin, for example, having a volume ranging from about 2 in³ to about 4 in³ (32.8 cm³ to 65.5 cm³). The recipe used to prepare the dough or batter-based food product includes any recipe that can be used to prepare a food product suitable for being cooked and frozen in a cooked state for later reheating.

After being initially cooked (i.e., precooked), one or more of the dough or batter-based food products can be inserted into a pouch and sealed for storage. The pouch is typically hot-sealed, for example, by using metal sealing jaws at a temperature of about 245° F. (118° C.) for a dwell time of about 2.5 seconds. The sealed pouch containing the dough or batter-based food products is then frozen, for example, at a temperature ranging from about −10° F. (−23.3° C.) to about 0° F. (−17.7° C.). The frozen dough or batter-based food product can then be stored for an extended period (e.g., about 12 to about 36 weeks) prior to being heated for consumption.

Heating of the frozen precooked dough or batter-based food product is typically conducted in a convection oven although a microwave or conventional oven may also be used. Heating temperatures typically range from about 325° F. (163° C.) to about 375° F. (191° C.) for times ranging from about 7 to about 15 minutes. The reheating temperature and time may vary for example, depending upon the type of oven, number of food products being reheated, whether the product is frozen or thawed, and the like. Heating is conducted in order to achieve a temperature suitable for serving the food product to a consumer. For example, the heated product may be at a temperature ranging from about 120° F. (48.9° C.) to about 180° F. (82.2° C.), although other temperatures may be suitable. After heating, the food product may be held at desired temperature in the pouch for a desired period of time, for example, to accommodate cafeteria-style serving or food service holding of the food product. For example, the heated dough or batter-based food product may be held for a time period ranging from about 10 minutes to about 240 minutes at a temperature ranging from about 130° F. (54.4° C.) to about 155° F. (65.6° C.).

The invention will now be described with reference to the following non-limiting examples.

### Examples

This example was conducted in order to determine if a relationship existed between the pancake crust moisture content and the vent area in the pouch. Samples having a range of vent area ratios were tested. Vent area ratios ranging from 0 to 0.125 m² were tested and crust moisture was measured for each vent structure. For the testing, crust moisture content was measured using a CEM brand microwave moisture analyzer. The CEM analyzer uses a balance and microwave energy to heat the sample, without burning, until all the moisture has evaporated. The frozen dough based food product was heated to the desired temperature in vented packaging in a convection oven. The food product was then removed from the pouch and a 1 to 3 gram sample of the crust was taken from the heated food product. The sample was deposited onto the sample balance of the CEM moisture analyzer and the crust moisture was measured. The CEM settings used were as follows.

### CEM Settings

| Description | Setting | |
|---|---|---|
| Power | 50% | |
| Change Wt. | 0.4 | mg |
| Time max | 15 | minutes |
| Temp max | 80° C. (176° F) | |
| Wt minimum | 1 | gram |
| Wt maximum | 3 | grams |

| | |
|---|---|
| Comp | On |

The settings cause the CEM machine to use 50% of the microwave power, and to measure the sample weight until it has stabilized to within 0.0004 grams over a time period of 10 seconds. The maximum time of the test was limited to 15 minutes, and the maximum allowed temperature of the food product was 80° C. (176° F.). In some instances, the maximum temperature setting on the CEM moisture analyzer was adjusted for a particular food product. For example, pancakes required a maximum temperature setting of 90° C. (194° F.), and breadsticks required a maximum temperature setting of 70° C. (158° C.) to prevent burning.

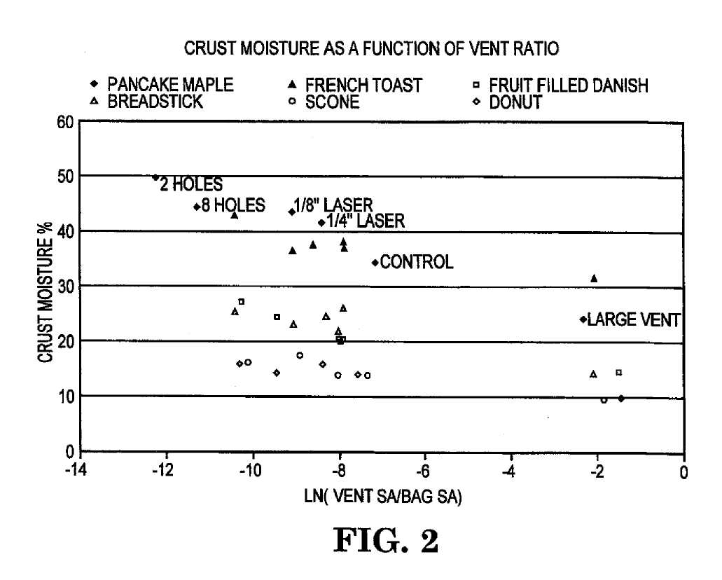

Initially, when crust moisture was plotted as a function of vent area the graph indicated an exponential relationship. The natural log (i.e., Ln) of the vent ratio was calculated and is plotted in FIG. 2. FIG. 2 shows the relationship between crust moisture content and vent area for various food products. FIG. 2 demonstrates that increasing the vent area allows more moisture to escape and thus results in a lower crust moisture. The data graphed in FIG. 2 is also provided in TABLES 1-6.

TABLE 1
Mini Maple Pancakes

| Vent ratio | % moist | Ln (vent ratio) |
|---|---|---|
| 0 | 49.86 | |
| 0.000004854 | 49.68 | −12.2357 |
| 0.000012816 | 44.34 | −11.2648 |
| 0.000116329 | 43.49 | −9.05909 |
| 0.000231288 | 41.54 | −8.37185 |
| 0.000794702 | 34.4 | −7.13754 |
| 0.098455598 | 24.19 | −2.31815 |

TABLE 2
Fruit Filled Danish

| Vent ratio | % moist | Ln (vent ratio) |
|---|---|---|
| 0 | 32.16 | |
| 0.000035389 | 27.17 | −10.249085 |
| 0.000081192 | 24.45 | −9.4186951 |
| 0.000330042 | 20.49 | −8.0162919 |
| 0.000342570 | 19.96 | −7.9790355 |
| 0.000367477 | 20.42 | −7.9088502 |
| 0.224803978 | 14.54 | −1.4925265 |

TABLE 3
French Toast

| Vent ratio | % moist | Ln (vent ratio) |
|---|---|---|
| 3.04599E−05 | 42.88 | −10.399098 |
| 0.000117062 | 36.49 | −9.052809 |
| 0.000189289 | 37.61 | −8.572238 |
| 0.000374466 | 38.15 | −7.8900107 |
| 0.000381000 | 37.03 | −7.8727112 |
| 0.127350967 | 31.61 | −2.0608085 |

TABLE 4
Breadsticks

| Vent ratio | % moist | Ln (vent ratio) |
|---|---|---|
| 3.0426E−05 | 25.39 | −10.400214 |
| 0.000118262 | 23.07 | −9.0426118 |
| 0.000250864 | 24.55 | −8.2905988 |
| 0.000327252 | 21.86 | −8.0247797 |
| 0.000369258 | 26.06 | −7.904016 |
| 0.123685838 | 14.25 | −2.0900105 |

TABLE 5
Scones

| Vent ratio | % moist | Ln (vent ratio) |
|---|---|---|
| 4.09528E−05 | 16.14 | −10.103089 |
| 0.000136258 | 17.43 | −8.9009579 |
| 0.000322478 | 13.84 | −8.0394748 |
| 0.000648787 | 13.81 | −7.3404065 |
| 0.158851351 | 9.55 | −1.8397864 |

TABLE 6
Donuts

| Vent ratio | % moist | Ln (vent ratio) |
|---|---|---|
| 3.367E−05 | 15.86 | −10.298902 |
| 0.000079745 | 14.26 | −9.4366788 |
| 0.000232006 | 15.79 | −8.368748 |
| 0.000515788 | 13.96 | −7.5698139 |
| 0.235939508 | 9.86 | −1.4441798 |

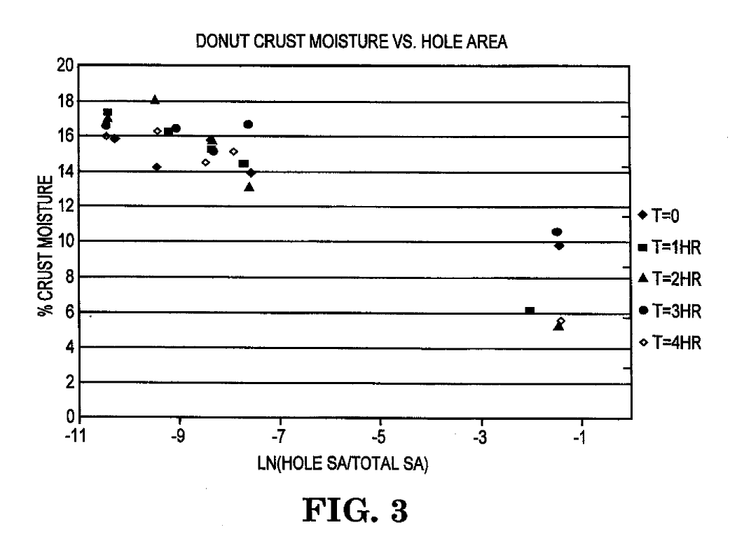

It was also shown that the crust moisture content was maintained over time when product was stored in a warmer. FIG. 3 shows that the crust moisture content given a vent ratio is maintained over the holding time. Frozen dough-based products (i.e., donuts) were heated in a convection oven and were then held in a warming cabinet for 4 hours at 150° F. (65.5° C.). The graph shows that the crust moisture content in relation to the specific vent ratio is maintained for four hours of holding time in a warming cabinet.

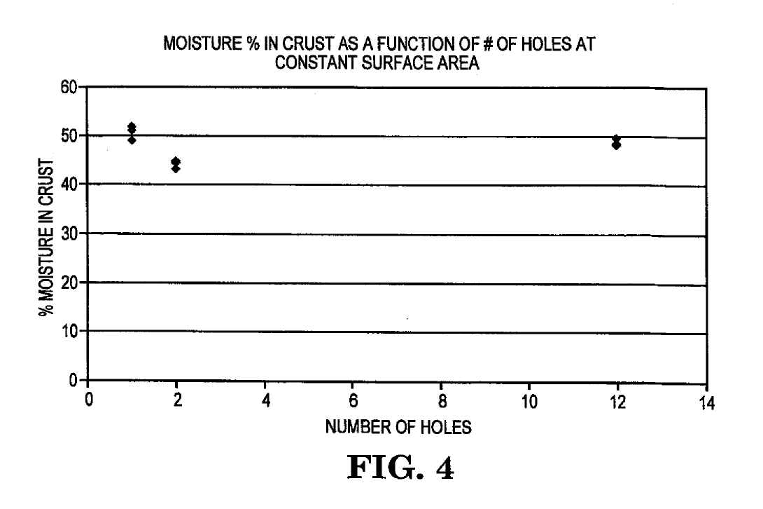

It was also shown that at a constant vent area ratio, the change in crust moisture percent as a function of the number of vent holes is negligible. Packages were tested at a constant vent area ratio while varying the number of vents used to attain the vent area ratio. The results show that crust moisture is affected by the vent area ratio, not the number of vents in the pouch. The results are presented in TABLE 8 and in FIG. 4.

TABLE 8
Data from pancakes at constant vent area

| Vent ratio | % moist | Ln (vent ratio) | # holes |
|---|---|---|---|
| 0.000849773 | 51.86 | −7.07054 | 1 |
| 0.000849773 | 51.08 | −7.07054 | 1 |
| 0.000849773 | 49 | −7.07054 | 1 |
| 0.000864500 | 44.38 | −7.05336 | 2 |
| 0.000864500 | 44.79 | −7.05336 | 2 |
| 0.000864500 | 43.14 | −7.05336 | 2 |
| 0.000800320 | 49.66 | −7.1305 | 12 |
| 0.000800320 | 48.51 | −7.1305 | 12 |
| 0.000800320 | 48.2 | −7.1305 | 12 |

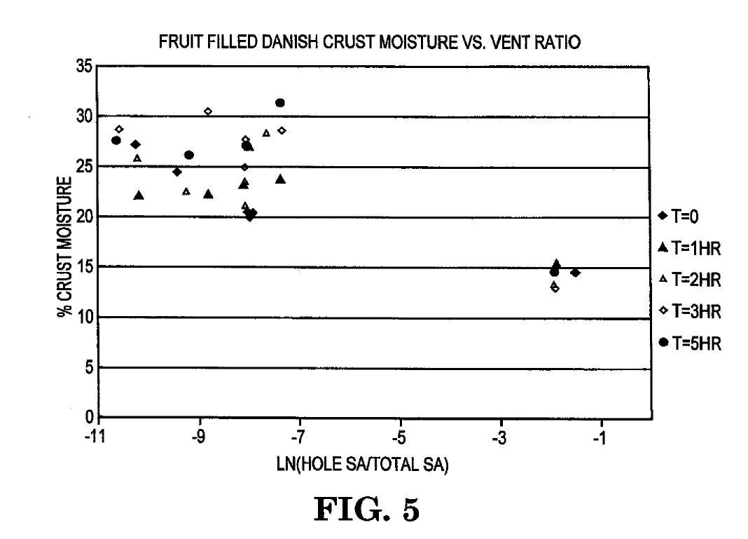

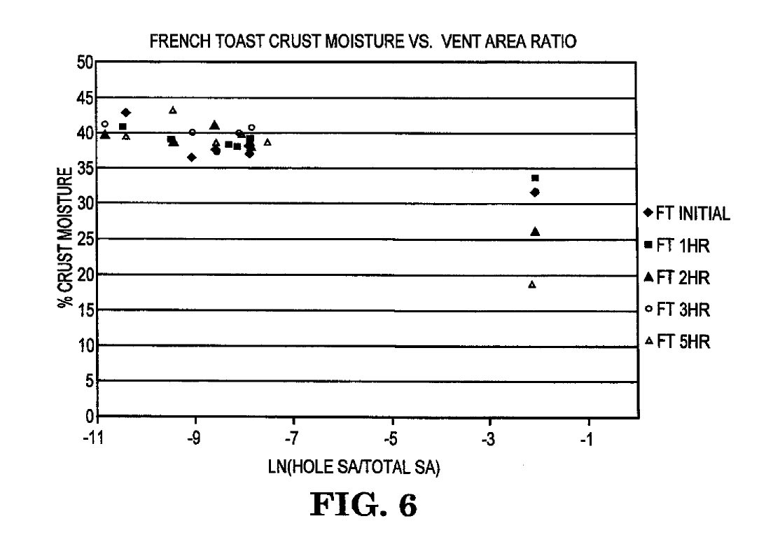

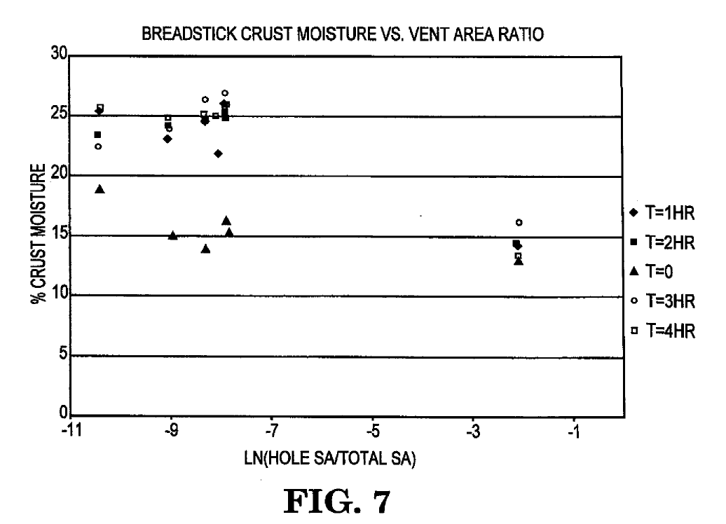

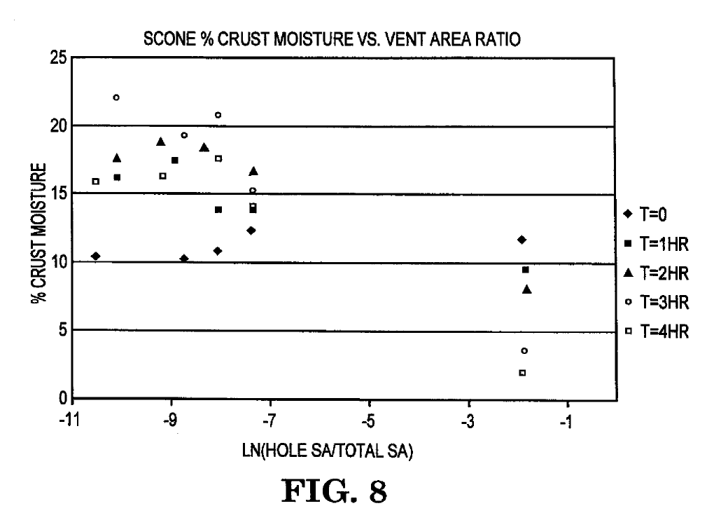

TABLES 9-11 and FIGS. 5-8 provide additional data on various embodiments of the invention that were tested.

TABLE 9
Mini Muffins Crust Moisture

| Vent ratio | % moist | Ln (vent ratio) | Product Type |
|---|---|---|---|
| 0.087837838 | 6.93 | −2.43226 | Blueberry muffin |
| 0.000533547 | 13.56 | −7.53596 | Blueberry muffin |
| 0.000018773 | 25.45 | −10.8831 | Blueberry muffin |
| 0.029166000 | 14.05 | −3.53496 | Apple cinnamon |
| 0.000823121 | 17.25 | −7.10241 | Apple cinnamon |
| 0.000811688 | 20.95 | −7.11639 | Apple cinnamon |
| 0.000235895 | 21.98 | −8.35212 | Apple cinnamon |
| 0.000117148 | 25.81 | −9.05207 | Apple cinnamon |
| 0.000013246 | 25.9 | −11.2318 | Apple cinnamon |

TABLE 10
Mini Waffles Crust Moisture

| Vent ratio | % moist | Ln (vent ratio) | Type |
|---|---|---|---|
| 0.124551724 | 30.61 | −2.08303 | waffle |
| 0.120599366 | 21.42 | −2.11528 | waffle |
| 0.000225788 | 42.5 | −8.39591 | waffle |
| 0.000225788 | 40.92 | −8.39591 | waffle |
| 0.000111477 | 46.42 | −9.10169 | waffle |
| 0.000115182 | 43.67 | −9.06899 | waffle |
| 0.000042953 | 37.84 | −10.0554 | waffle |
| 0.000022063 | 39.19 | −10.7216 | waffle |
| 0.000006573 | 43.53 | −11.9326 | waffle |
| 0.000020294 | 41.06 | −10.8052 | waffle |

TABLE 11
French Toast Mini Sticks crust moisture

| Vent ratio | % moist | Ln (vent ratio) | Type |
|---|---|---|---|
| 0.102857143 | 32.91 | −2.27441 | French toast |
| 0.000222836 | 41.36 | −8.40907 | French toast |
| 0.000218551 | 37.43 | −8.42849 | French toast |
| 0.000121764 | 33.35 | −9.01342 | French toast |
| 7.3076E−05 | 42.63 | −9.52401 | French toast |
| 7.16161E−06 | 39.05 | −11.8468 | French toast |

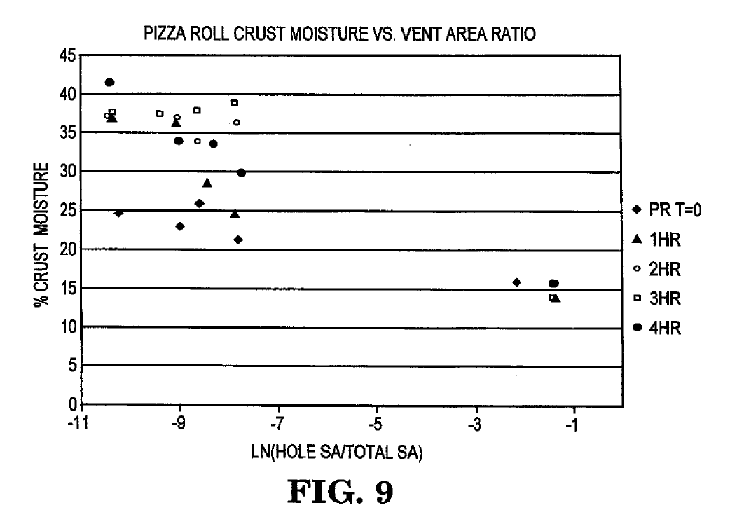

In some embodiments, the precooked frozen dough or batter-based food products have a very high water activity filling (e.g. pizza rolls) which causes a change in crust moisture content over hold time. Frozen Pizza rolls are an example where the water activity is greater than 0.95. The data in FIG. 9 demonstrate that, for pizza rolls, the crust moisture increases as warmer hold time increases.

Other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by the following claims.

What is claimed is:

1. A packaged frozen precooked dough or batter-based food product comprising:
(a) one or more frozen precooked dough or batter-based food products; and
(b) a heatable pouch comprising heatable film, the heatable pouch encasing the one or more frozen precooked dough or batter-based food products; wherein the heatable pouch includes two or more vent holes in the heatable film that provide a vent area ratio ranging from 0.00005 to about 0.001 (vent area m²/pouch area m²).

2. The food product of claim 1, wherein the frozen precooked dough or batter-based food products are selected from the group consisting of pancakes, fruit filled Danish, French toast, scones, muffins, waffles, breadsticks, donuts, pizza rolls and cinnamon rolls.

3. The food product of claim 1, wherein the pouch encases from about 2 to about 6 frozen dough or batter-based food products.

4. The food product of claim 1, wherein the heatable pouch comprises polyester or nylon.

5. The food product of claim 1, wherein the heatable pouch contains from about 20 or less vent holes.

6. The food product of claim 1, wherein the heatable pouch contains from about 6 to about 12 vent holes.

7. The food product of claim 1, wherein the vent holes have a shape that is circular, triangular, square, T-shaped, V-shaped, hexagonal, or linear.

8. The food product of claim 1, wherein the frozen precooked dough or batter-based food product can be heated in an oven to provide a heated dough or batter-based food product having a crust moisture content ranging from about 10% to about 45%.

9. The food product of claim 1, wherein the precooked dough or batter-based food product can be heated in an oven at a temperature ranging from about 325° F. (163° C.) to about 375° F. (191° C.) for a time period ranging from about 7 to about 15 minutes to form a heated dough or batter-based food product having a crust moisture content ranging from about 10% to about 45%.

10. The food product of claim 1, wherein the precooked dough or batter-based food product can be heated in an oven at a temperature ranging from about 325° F. (163° C.) to about 375° F. (191° C.) to a time period ranging from about 7 to about 15 minutes to form a heated dough or batter-based food product having a crust moisture content from about 10% to about 45%, and held at a temperature of from about 120° F. (48.9° C.) to about 180° F. (82.2° C.) for a time period of about 30 to 240 minutes, wherein the heated food product has a crust moisture content ranging from about 10% to about 45%.

11. A method of preparing a heated dough or batter-based food product from a frozen packaged dough or batter-based food product, the method comprising the steps of:
(a) providing one or more frozen precooked dough or batter-based food products encased in a heatable pouch; wherein the heatable pouch includes two or more vent holes that provide a vent area ratio ranging from about 0.00005 to about 0.001 (vent area m²/pouch area m²); and
(b) heating the frozen precooked dough or batter-based food products in the heatable pouch in order to form a heated dough or batter-based food product having a temperature of from 120° F. (48.9° C.) to about 180° F. (82.2° C.).

12. The method of claim 11, wherein the method further comprises the step of holding the heated dough or batter-based food product at a temperature ranging from about 120° F. (48.9° C.) to about 180° F. (82.2° C.) for a time period of about 30 to 240 minutes; wherein the heated dough or batter-based food product has a crust moisture content ranging from about 10% to about 60%.

13. A method of preparing a food product, the method comprising:
(a) providing a packaged food product, the food product including one or more frozen precooked pancakes encased in a heatable pouch comprising a heatable film, the heatable pouch encasing the one or more frozen precooked pancakes; wherein the heatable pouch includes two or more vent holes in the heatable film that provide a vent area ratio ranging from 0.00005 to about 0.001 (vent area m²/pouch area m²),
(b) heating the food product in an oven at a temperature ranging from about 325° F. (163° C.) to about 375° F. (191° C.) to a time period ranging from about 7 to about 15 minutes to form a heated pancake having a crust moisture content from about 35% to about 45%, and
(c) holding the heated pancake at a temperature of from about 120° F. (48.9° C.) to about 180° F. (82.2° C.) for a time period of about 30 to 240 minutes, wherein throughout the heated hold period the heated pancake has a crust moisture content ranging from about 10% to about 45%.
